(19) United States
(12) Patent Application Publication
(10) Pub. No.: US 2015/0192148 A1
(43) Pub. Date: Jul. 9, 2015

(54) HYDRAULIC CIRCUIT FOR WORKING MACHINE, COMPRISING ACCUMULATOR

(71) Applicant: CATERPILLAR SARL, Geneva (CH)

(72) Inventor: Yasutoshi Nanyoshi, Tokyo (JP)

(21) Appl. No.: 14/412,933

(22) PCT Filed: Jun. 12, 2013
(86) PCT No.: PCT/JP2013/066164

§ 371 Date: Jan. 5, 2015

(30) Foreign Application Priority Data
Jul. 3, 2012 (JP) 2012-149271

(51) Int. Cl. F15B 1/02; F15B 21/14; E02F 9/22; F15B 21/04

(52) U.S. Cl. CPC F15B 1/024; F15B 21/042; F15B 21/14; E02F 9/2217

(57) ABSTRACT

The present invention relates to a hydraulic circuit for a working machine including: a hydraulic actuator; and an accumulator for accumulating hydraulic energy which is discharged from the hydraulic actuator, and addresses the problem of configuring the hydraulic circuit so that high-temperature hydraulic oil does not flow into the accumulator. Means for solving the problem is to configure the hydraulic circuit in such a manner that piping for cooling having a volume equivalent to the accumulation volume of the accumulator is provided in an accumulator inflow/outflow oil passage serving as the inflow oil passage of hydraulic oil to the accumulator and the hydraulic oil cooled in the piping for cooling is accumulated in the accumulator.

### CROSS-REFERENCE TO RELATED APPLICATIONS

This application is a National Stage of International Patent Application No. PCT/JP2013/0066164, filed Jun. 12, 2013, which claims priority to foreign Japanese Patent Application No. 2012-149271, filed Jul. 3, 2012, the contents of which are incorporated herein by reference in their entirety.

### TECHNICAL FIELD

The present invention relates to the technical field of a hydraulic circuit for a working machine provided with an accumulator for hydraulic energy accumulation.

### BACKGROUND

Among hydraulic drive type working machines such as a hydraulic shovel, there is a working machine configured so as to be able to accumulate high-temperature oil which is generated due to the potential energy of the working device or an inertial force of a swing operation of the working device, in an accumulator as hydraulic energy, and on the other hand, reuse the accumulated oil of the accumulator as supply oil to a hydraulic actuator, in order to attain improvement of fuel efficiency or exhaust gas reduction.

For example, in a hydraulic shovel, a working device is configured by mounting an arm, a bucket, or the like on a tip portion of a boom which is supported on a machine body so as to be able to swing upward and downward, and on the other hand, the upward and downward movements of the boom are performed based on extension and retraction operations of a boom cylinder. However, in this hydraulic shovel, when the working device is moved downward in a state where the bucket is not grounded, high-pressure oil is discharged from a head-side oil chamber of the boom cylinder due to the potential energy of the wording device. Therefore, a technique is known which makes it possible for high-pressure discharge oil from a head-side oil chamber of a boom cylinder, which has been returned to an oil tank in the past, to be reused by making a configuration such that at the time of the downward movement of a boom, discharge oil from the head-side oil chamber of the boom cylinder is accumulated in an accumulator, and on the other hand, the accumulated oil of the accumulator is supplied to the head-side oil chamber of the boom cylinder at the time of the upward movement of the boom (refer to, for example, PTL 1).

### CITATION LIST

### Patent Literature

[PTL 1] JP-A-2012-13123

### SUMMARY OF INVENTION

### Technical Problem

Incidentally, since the discharge oil from the hydraulic actuator is hydraulic oil used for the driving of the hydraulic actuator, the discharge oil has a high temperature, and for this reason, in the configuration of the related art in which the discharge oil from the hydraulic actuator is returned to an oil tank, a configuration is made such that the discharge oil from the hydraulic actuator is cooled by an oil cooler disposed on the upstream side of the oil tank. However, in the configuration in which hydraulic oil which is discharged from the hydraulic actuator is accumulated in the actuator, as in PTL 1 described above, the hydraulic oil which is used for the driving of the hydraulic actuator, thereby having a high temperature, is accumulated in the actuator as it is. Thus, high-temperature hydraulic oil is accumulated in the accumulator. However, the high-temperature hydraulic oil degrades the quality of the material of the accumulator, thereby shortening the durability life, and for this reason, it is necessary to adopt an expensive accumulator having heat resistance, and thus there is a problem of high cost, and a problem that the invention is to solve is present here.

### Solution to Problem

The present invention has been created for the purpose of solving the above problems in view of the above-mentioned circumstances, and the invention according to Claim 1 relates to a hydraulic circuit for a working machine provided with an accumulator, including: a hydraulic actuator; and the accumulator which accumulates hydraulic energy which is discharged from the hydraulic actuator, and on the other hand, supplies the accumulated hydraulic energy to the hydraulic actuator, wherein piping for cooling having a volume equivalent to accumulation volume of the accumulator is disposed in an inflow oil passage of hydraulic oil to the accumulator, and the hydraulic oil cooled in the piping for cooling is accumulated in the accumulator.

The invention according to Claim 2 relates to a hydraulic circuit for a working machine provided with an accumulator, in which in the hydraulic circuit for a working machine provided with an accumulator according to Claim 1, the piping for cooling is disposed in a meandering shape or a spiral shape.

The invention according to Claim 3 relates to a hydraulic circuit for a working machine provided with an accumulator, in which in the hydraulic circuit for a working machine provided with an accumulator according to Claim 1 or 2, the piping for cooling is divided into a plurality of flow paths which are disposed in parallel.

The invention according to Claim 4 relates to a hydraulic circuit for a working machine provided with an accumulator, in which in the hydraulic circuit for a working machine provided with an accumulator according to any one of Claims 1 to 3, the piping for cooling is disposed in an accumulator inflow/outflow oil passage serving as an oil passage for inflow and outflow of the hydraulic oil to and from the accumulator, and a floating body which moves along with flow of the hydraulic oil, thereby preventing mixing of the hydraulic oil, is disposed in the piping for cooling.

The invention according to Claim 5 relates to a hydraulic circuit for a working machine provided with an accumulator, in which the hydraulic circuit for a working machine provided with an accumulator according to any one of Claims 1 to 4 further includes: cooling means for cooling the hydraulic oil flowing through the piping for cooling.

### Advantageous Effects of Invention

According to the invention of Claim 1, in the accumulator, low-temperature hydraulic oil cooled in the piping for cooling is accumulated, rather than high-temperature hydraulic oil which is discharged from the hydraulic actuator being accumulated as it is, and as a result, it is possible to reliably suppress the degradation of the quality of the material of the accumulator due to the high temperature of the hydraulic oil, and thus it is possible to lengthen the service life of the accumulator, and in addition, it is not necessary to use an expensive accumulator having heat resistance, thereby being able to greatly contribute to a cost reduction.

According to the invention of Claim 2, the piping for cooling can be compactly stored.

According to the invention of Claim 3, heat convection in the piping for cooling can be reduced, and thus the high-temperature hydraulic oil which is discharged from the hydraulic actuator and the low-temperature hydraulic oil in the piping for cooling can be prevented from being stirred.

According to the invention of Claim 4, due to the floating body, the high-temperature hydraulic oil which is discharged from the hydraulic actuator and the low-temperature hydraulic oil in the piping for cooling can be prevented from being mixed.

According to the invention of Claim 5, the hydraulic oil in the piping for cooling can be more effectively cooled.

### BRIEF DESCRIPTION OF DRAWINGS

FIG. 1 is a hydraulic circuit for a boom cylinder in a first embodiment.

FIG. 2(A) is a diagram showing piping for cooling of the first embodiment, and FIG. 2(B) is a diagram showing a disposition state of an accumulator and the piping for cooling.

FIG. 3 is a hydraulic circuit for a boom cylinder in a second embodiment.

FIG. 4(A) is a diagram showing piping for cooling of a third embodiment, and FIG. 4(B) is a diagram showing piping for cooling of a fourth embodiment.

FIG. 5(A) is a diagram showing piping for cooling of a fifth embodiment, FIG. 5(B) is an enlarged cross-sectional view along line X-X of FIG. 5(A), FIG. 5(C) is a diagram showing piping for cooling of a sixth embodiment, and FIG. 5(D) is an enlarged cross-sectional view along line X-X of FIG. 5(C).

### DESCRIPTION OF EMBODIMENTS

Hereinafter, embodiments of the present invention will be described based on the drawings.

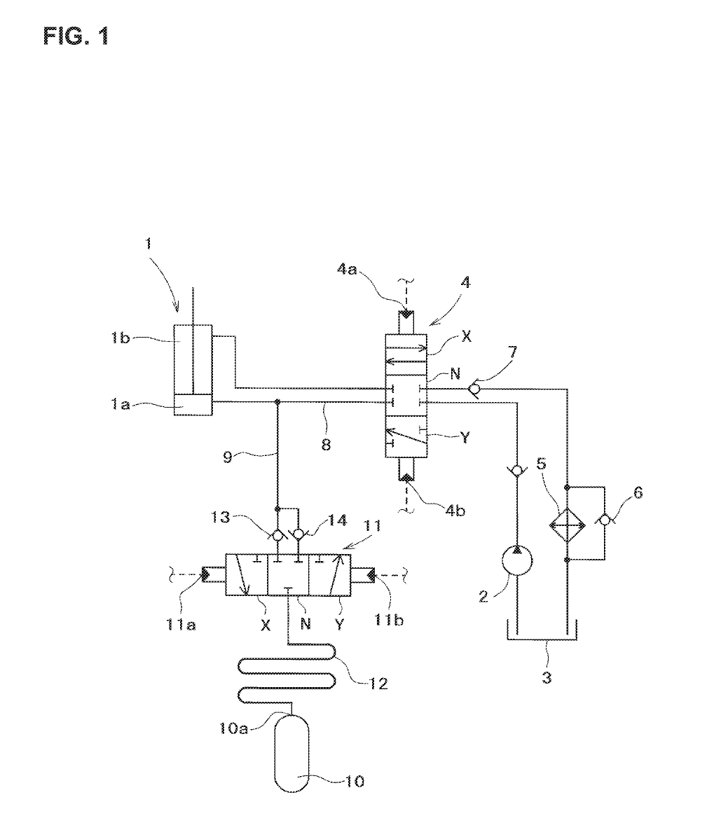

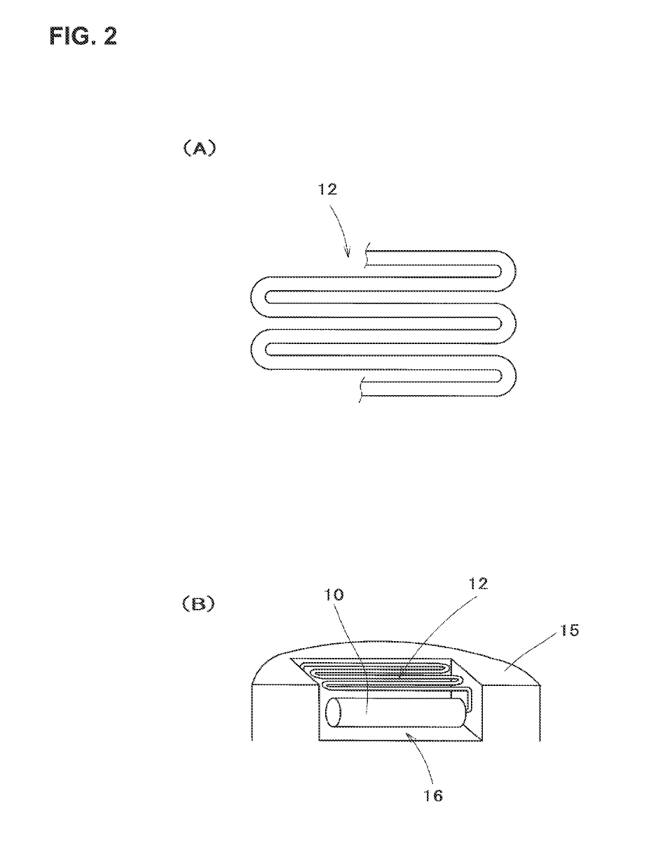

First, a first embodiment will be described based on FIGS. 1 and 2, in which FIG. 1 is a diagram showing a hydraulic circuit for a boom cylinder in a hydraulic shovel which is an example of a working machine, and in FIG. 1, reference numeral 1 denotes the boom cylinder (equivalent to a hydraulic accumulator in the present invention), reference numeral 2 denotes a hydraulic pump which is driven by an engine (not shown) mounted on the hydraulic shovel, reference numeral 3 denotes an oil tank, reference numeral 4 denotes a control valve, reference numeral 5 denotes an oil cooler, reference numeral 6 denotes a bypass check valve for the coil cooler, and reference numeral 7 denotes a back pressure valve.

The boom cylinder 1 performs extension and retraction operations so as to move a boom (not shown) upward and downward, which is supported on a machine body of the hydraulic shovel so as to be able to move upward and downward, and is extended by oil supply to a head-side oil chamber 1a and oil discharge from a rod-side oil chamber 1b, thereby moving the boom upward, and is retracted by oil supply to the rod-side oil chamber 1b and oil discharged from the head-side oil chamber 1a, thereby moving the boom downward. In addition, although not shown in the drawings, an arm is swingably supported on a tip portion of the boom and a bucket is swingably supported on a tip portion of the arm, and a front working device of the hydraulic shovel is composed of the boom, the arm, the bucket, and the like, and in a state where the bucket is not grounded, the weight of the front working device is maintained by the pressure of the head-side oil chamber 1a of the boom cylinder 1, and thus, at the time of the downward movement of the boom, high-pressure hydraulic oil having high hydraulic energy is discharged from the head-side oil chamber 1a of the boom cylinder 1.

Further, the control valve 4 is a flow rate control/switching valve which performs oil supply/discharge control with respect to the boom cylinder 1 based on an operation of an operating tool for a boom (not shown), and is provided with pilot ports 4a and 4b on the upward movement side and the downward movement side. Then, in a state where pilot pressure is not input to both the pilot ports 4a and 4b on the upward movement side and the downward movement side, the control valve 4 is located at a neutral position N where discharge oil of the hydraulic pump 2 is not supplied to the head-side oil chamber 1a and the rod-side oil chamber 1b of the boom cylinder 1 and oil of the head-side oil chamber 1a and the rod-side oil chamber 1b does not flow to the oil tank 3. However, the pilot pressure is input to the upward movement side pilot port 4a, whereby the control valve 4 is switched to an upward movement side position X where discharge oil of the hydraulic pump 2 is supplied to the head-side oil chamber 1a and discharge oil from the rod-side oil chamber 1b flows to the oil tank 3. Further, the pilot pressure is input to the downward movement side pilot port 4b, whereby the control valve 4 is switched to a downward movement side position Y where the discharge oil of the hydraulic pump 2 is supplied to the rod-side oil chamber 1b. However, at the downward movement side position Y, the control valve 4 is configured such that discharge oil from the head-side oil chamber 1a does not flow to the oil tank 3. In addition, a configuration is made such that the input of the pilot pressure to the upward movement side and downward movement side pilot ports 4a and 4b of the control valve 4 is performed based on the upward movement side and downward movement side operations of the operating tool for a boom.

In addition, in FIG. 1, reference numeral 8 denotes a head-side oil passage which connects the control valve 4 and the head-side oil chamber 1a of the boom cylinder 1, and an accumulator 10 is connected to the head-side oil passage 8 through an accumulator inflow/outflow oil passage 9. The accumulator 10 is for hydraulic energy accumulation, and for example, a piston type accumulator or a bladder type accumulator is used. Further, the accumulator inflow/outflow oil passage (equivalent to an inflow oil passage of hydraulic oil to an accumulator in the present invention and an accumulator inflow/outflow oil passage serving as an oil passage for inflow and outflow of the hydraulic oil to and from an accumulator) 9 is an oil passage which connects the head-side oil passage 8 and an oil supply/discharge port 10a of the accumulator 10 and is an oil passage serving as an inflow oil passage and an outflow oil passage of the hydraulic oil to and from the accumulator 10, and a control valve for an accumulator 11 (described later) is disposed in the accumulator inflow/outflow oil passage 9, and piping for cooling 12 is disposed in the accumulator inflow/outflow oil passage 9 between the control valve for an accumulator 11 and the accumulator 10.

The control valve for an accumulator 11 is a flow rate control/switching valve which controls the inflow and the outflow of the hydraulic oil to and from the accumulator 10 and is provided with pilot ports 11a and 11b on the inflow side and the outflow side. Then, in a state where pilot pressure is not input to both the pilot ports 11a and 11b on the inflow side and the outflow side, the control valve for an accumulator 11 is located at a neutral position N where the inflow and the outflow of the hydraulic oil to and from the accumulator 10 are not performed. However, the pilot pressure is input to the inflow-side pilot port 11a, whereby the control valve for an accumulator 11 is switched to an inflow-side position X where the hydraulic oil of the head-side oil passage 8 flows to the piping for cooling 12 through an inflow-side check valve 13, and in this way, the hydraulic oil of the head-side oil passage 8 flows into the piping for cooling 12 and the hydraulic oil of the piping for cooling 12 flows into the accumulator 10, thereby being accumulated therein. Further, the pilot pressure is input to the outflow-side pilot port 11b, whereby the control valve for an accumulator 11 is switched to an outflow-side position Y where the hydraulic oil of the piping for cooling 12 flows to the head-side oil passage 8 through an outflow-side check valve 14, and in this way, the hydraulic oil of the piping for cooling 12 flows out to the head-side oil passage 8 and the accumulated oil of the accumulator 10 is released to the piping for cooling 12. In addition, a configuration is made such that the input of the pilot pressure to the inflow-side and outflow-side pilot ports 11a and 11b of the control valve for an accumulator 11 is performed based on a control command from a controller (not shown).

On the other hand, the piping for cooling 12 is piping which is provided in order to cool the hydraulic oil which is accumulated in the accumulator 10, and has a volume equivalent to the accumulation volume of the accumulator 10 (a volume equal to the maximum volume enabling accumulation in the accumulator 10). Thus, in a case where the hydraulic oil of the head-side oil passage 8 flows into the piping for cooling 12 by way of the control valve for an accumulator 11 switched to the inflow-side position X, the hydraulic oil of the head-side oil passage 8 does not flow to the accumulator 10 and the hydraulic oil in the piping for cooling 12 is accumulated in the accumulator 10.

Here, the piping for cooling 12 is provided by bending a long tube into a meandering shape, as shown in FIG. 2(A), and in this way, the surface area of the piping for cooling 12 is increased, and thus the piping for cooling 12 can be compactly stored while heat exchange between the hydraulic oil in the piping for cooling 12 and the outside air is promoted. Then, the hydraulic oil cooled in the piping for cooling 12 is accumulated in the accumulator 10, whereby it is possible to maintain the temperature of the accumulated oil in the accumulator 10 at a low temperature close to an outside air temperature.

Further, the accumulator 10 and the piping for cooling 12 are disposed at a proper place of the hydraulic shovel. However, in this embodiment, as shown in FIG. 2(B), an accumulator storage portion 16 is formed in a counterweight 15 which is mounted on a rear portion of a machine body of the hydraulic shovel, and the accumulator 10 is stored in the accumulator storage portion 16, and the piping for cooling 12 bent into a meandering shape is then disposed on the upper side of the accumulator storage portion 16, and thus the piping for cooling 12 serves as a cover which covers the upper side of the accumulator storage portion 16. Due to such a configuration, it is not necessary to separately secure a space for the piping for cooling 12, and in addition, it is possible to dispose the piping for cooling 12 at a place which outside air touches.

Subsequently, the accumulation and release operations of the accumulator 10 according to the downward movement and the upward movement of the boom will be described.

First, at the time of the downward movement of the boom, that is, if the operating tool for a boom is operated to the downward movement side, the pilot pressure is input to the downward movement side pilot port 4b of the control valve 4, and thus the control valve 4 is switched to the downward movement side position Y, and the pilot pressure is input to the inflow-side pilot port 11a of the control valve for an accumulator 11 based on the control command of the controller, and thus the control valve for an accumulator 11 is switched to the inflow-side position X. In this state, the discharge oil of the hydraulic pump 2 is supplied to the rod-side oil chamber 1b of the boom cylinder 1 by way of the control valve 4 and the discharge oil from the head-side oil chamber 1a of the boom cylinder 1 flows into the head-side oil passage 8 and then flows from the head-side oil passage 8 to the piping for cooling 12 by way of the inflow-side check valve 13 and the control valve for an accumulator 11. In this way, the hydraulic oil of the piping for cooling 12 flows into the accumulator 10, thereby being accumulated in the accumulator 10, and thus, hydraulic energy which is discharged from the head-side oil chamber 1a at the time of the downward movement of the boom is accumulated in the accumulator 10.

On the other hand, at the time of the upward movement of the boom, that is, if the operating tool for a boom is operated to the upward movement side, the pilot pressure is input to the upward movement side pilot port 4a of the control valve 4, and thus the control valve 4 is switched to the upward movement side position X and the pilot pressure is input to the outflow-side pilot port 11b of the control valve for an accumulator 11 based on the control command of the controller, and thus the control valve for an accumulator 11 is switched to the outflow-side position Y. In this state, the discharge oil of the hydraulic pump 2 is supplied to the head-side oil chamber 1a of the boom cylinder 1 by way of the control valve 4, and the discharge oil from the rod-side oil chamber 1b is discharged to the oil tank 3 by way of the control valve 4 and the accumulated oil of the accumulator 10 is released to the piping for cooling 12, and thus the hydraulic oil of the piping for cooling 12 is supplied to the head-side oil passage 8 by way of the control valve for an accumulator 11 and the check valve for outflow 14. Then, the hydraulic oil supplied from the piping for cooling 12 to the head-side oil passage 8 joins the discharge oil of the hydraulic pump 2 which is supplied from the control valve 4, and is then supplied to the head-side oil chamber 1a of the boom cylinder 1. Thus, a configuration is made in which the hydraulic energy accumulated in the accumulator 10 at the time of the downward movement of the boom can be reused at the time of the upward movement of the boom.

In this form configured as described above, in the hydraulic circuit of the hydraulic shovel, the boom cylinder 1 for moving the boom upward and downward is provided and the accumulator 10 which accumulates the hydraulic energy which is discharged from the boom cylinder 1 at the time of the downward movement of the boom, and on the other hand, supplies the accumulated hydraulic energy to the boom cylinder 1 at the time of the upward movement of the boom, is also provided. However, the piping for cooling 12 having a volume equivalent to the accumulation volume of the accumulator 10 is disposed in the accumulator inflow/outflow oil passage 9 serving as the inflow oil passage of the hydraulic oil to the accumulator 10, and thus the hydraulic oil cooled in the piping for cooling 12 is accumulated in the accumulator 10.

Thus, in the accumulator 10, low-temperature hydraulic oil cooled in the piping for cooling 12 is accumulated, rather than high-temperature hydraulic oil which is discharged from the boom cylinder 1 being accumulated as it is, and accordingly, it is possible to make the temperature of the hydraulic oil which is accumulated in the accumulator 10a temperature sufficiently lower than an allowable temperature (for example, about 90° C.) of the hydraulic circuit for a boom cylinder. As a result, it is possible to reliably suppress the degradation of the quality of the material of the accumulator 10 due to the high temperature of the hydraulic oil, and thus it is possible to lengthen the service life of the accumulator 10, and in addition, it is not necessary to use an expensive accumulator having heat resistance, thereby being able to greatly contribute to a cost reduction.

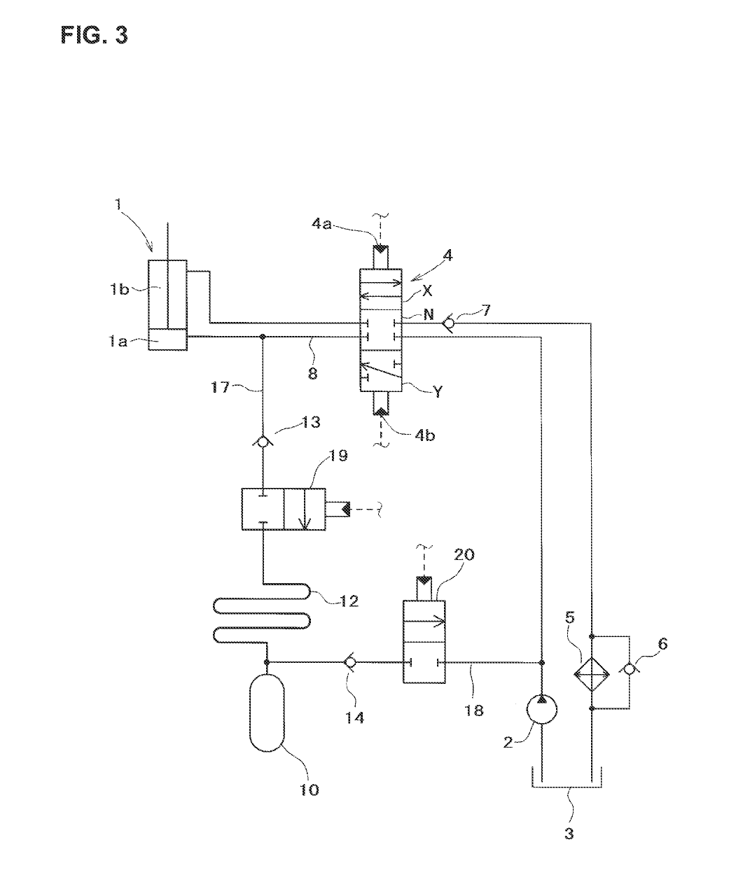

Subsequently, a second embodiment will be described based on FIG. 3. The second embodiment has a configuration made such that an accumulator inflow oil passage 17 and an accumulator outflow oil passage 18 are separately provided and thus the inflow of the hydraulic oil to the accumulator 10 is performed by way of the accumulator inflow oil passage 17 and on the other hand, the outflow of the hydraulic oil from the accumulator 10 is performed by way of the accumulator outflow oil passage 18, rather than a configuration in which the inflow and the outflow to and from an accumulator are performed by way of an accumulator inflow/outflow oil passage, as in the first embodiment. Then, also in a hydraulic circuit in which the accumulator inflow oil passage 17 and the accumulator outflow oil passage 18 are separately provided in this manner, the present invention can be implemented by providing the piping for cooling 12 in the accumulator inflow oil passage 17. In addition, in the second embodiment, a constituent element in common with the first embodiment (equal to that in the first embodiment) is denoted by the same reference numeral and detailed description thereof is omitted.

That is, in the configuration of the second embodiment, the accumulator 10 is connected to the head-side oil passage 8 through the accumulator inflow oil passage 17 and on the other hand, is connected to the discharge side of the hydraulic pump 2 through the accumulator outflow oil passage 18. In the accumulator inflow oil passage 17, the inflow-side check valve 13, a control valve for accumulator inflow 19 which is switched by the control command from the controller, and the piping for cooling 12 which is the same as that in the first embodiment having a volume equivalent to the accumulation volume of the accumulator 10 are disposed. Further, in the accumulator outflow oil passage 18, the check valve for outflow 14 and a control valve for accumulator outflow 20 which is switched by the control command from the controller are disposed. Then, a configuration is made such that at the time of the downward movement of the boom, the hydraulic oil discharged from the head-side oil chamber 1a of the boom cylinder 1 to the head-side oil passage 8 flows into the piping for cooling 12 by way of the inflow-side check valve 13 and the control valve for accumulator inflow 19, and thus the hydraulic oil of the piping for cooling 12 is accumulated in the accumulator 10. On the other hand, a configuration is made such that at the time of the upward movement of the boom, the accumulated oil of the accumulator 10 is supplied to the discharge side of the hydraulic pump 2 by way of the outflow-side check valve 14 and the control valve for accumulator outflow 20, joins the discharge oil of the hydraulic pump 2, is then supplied to the control valve 4, and is supplied from the control valve 4 to the head-side oil chamber 1a of the boom cylinder 1.

Then, also in the second embodiment in which the accumulator inflow oil passage 17 and the accumulator outflow oil passage 18 are separately provided in this manner, low-temperature hydraulic oil can be accumulated in the accumulator 10 due to the piping for cooling 12 provided in the accumulator inflow oil passage 17, and thus the same operation and effects as those in the first embodiment are exhibited.

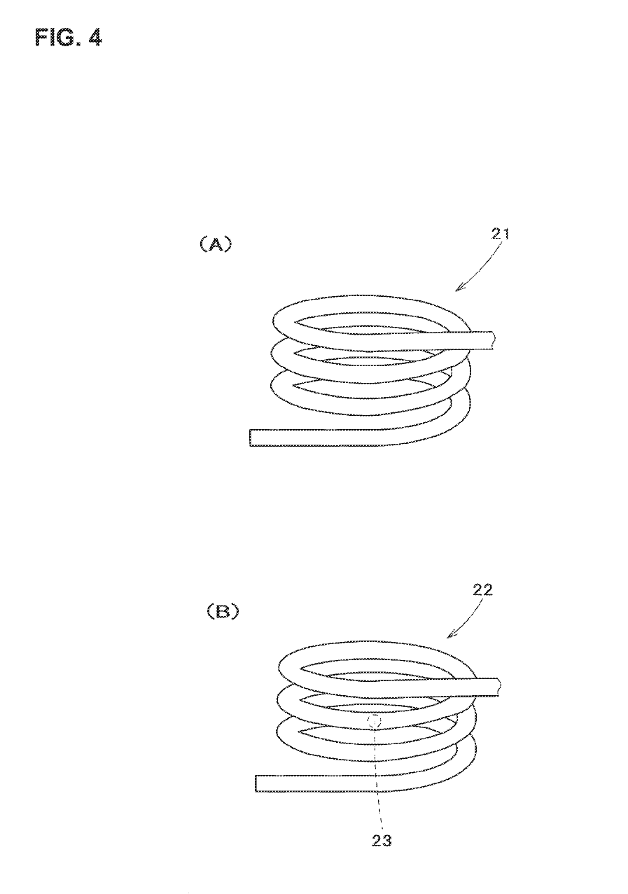

In addition, in the present invention, in disposing the piping for cooling, a long tube may be disposed to be bent into a spiral shape, like piping for cooling 21 of a third embodiment shown in FIG. 4(A). Also in a case where a long tube is disposed in a spiral shape in this manner, it is possible to increase the surface area of the piping for cooling 21, and thus the piping for cooling 21 can be compactly stored while promoting heat exchange between the hydraulic oil in the piping for cooling 21 and the outside air.

Further, as in a fourth embodiment shown in FIG. 4(B), a configuration is also possible in which a floating body 23 which moves along with the flow of the hydraulic oil is disposed in piping for cooling 22, and due to the floating body 23, high-temperature hydraulic oil which is discharged from a hydraulic actuator (the boom cylinder 1) and low-temperature hydraulic oil cooled in the piping for cooling 22 are prevented from being mixed in the piping for cooling. In this case, the floating body 23 is disposed in the piping for cooling 22 so as to be located on the starting end side (a hydraulic actuator-side end portion) of the piping for cooling 22 in a state where the hydraulic oil is not accumulated in the accumulator 10 and on the other hand, be located on the terminus side (an accumulator-side end portion) of the piping for cooling 22 in a state where the greatest amount of hydraulic oil is accumulated in the accumulator 10, and is made so as to move from the starting end side of the piping for cooling 22 to the terminus side at the time of hydraulic oil accumulation into the accumulator 10 and move from the terminus side to the starting end side at the time of hydraulic oil release from the accumulator 10. Then, due to the floating body 23 moving along with the flow of the hydraulic oil, it is possible to prevent the high-temperature hydraulic oil which is discharged from the hydraulic actuator and the low-temperature hydraulic oil cooled in the piping for cooling 22 from being mixed in the piping for cooling 22. In addition, in a case of disposing the floating body 23 in the piping for cooling 22, stoppers (not shown) for preventing the floating body 23 from escaping from the piping for cooling 22 may be provided on the starting end side and the terminus side of the piping for cooling 22. Further, the piping for cooling 22 is required to be disposed in a state where the movement of the floating body 23 is smoothly performed, and is disposed in a state of being bent in a spiral shape, for example, as shown in FIG. 4(B). In addition, the floating body 23 moves between the starting end side and the terminus side of the piping for cooling 22 along with the flow of the hydraulic oil according to the accumulation and the release in the accumulator 10, as described above, and therefore, the floating body 23 can be adopted in a hydraulic circuit in which piping for cooling is disposed in an accumulator inflow/outflow oil passage serving as an inflow oil passage and an outflow oil passage of an accumulator, as in the first embodiment. However, the floating body 23 cannot be adopted in a hydraulic circuit in which an accumulator inflow oil passage and an accumulator outflow oil passage are separately provided, as in the second embodiment.

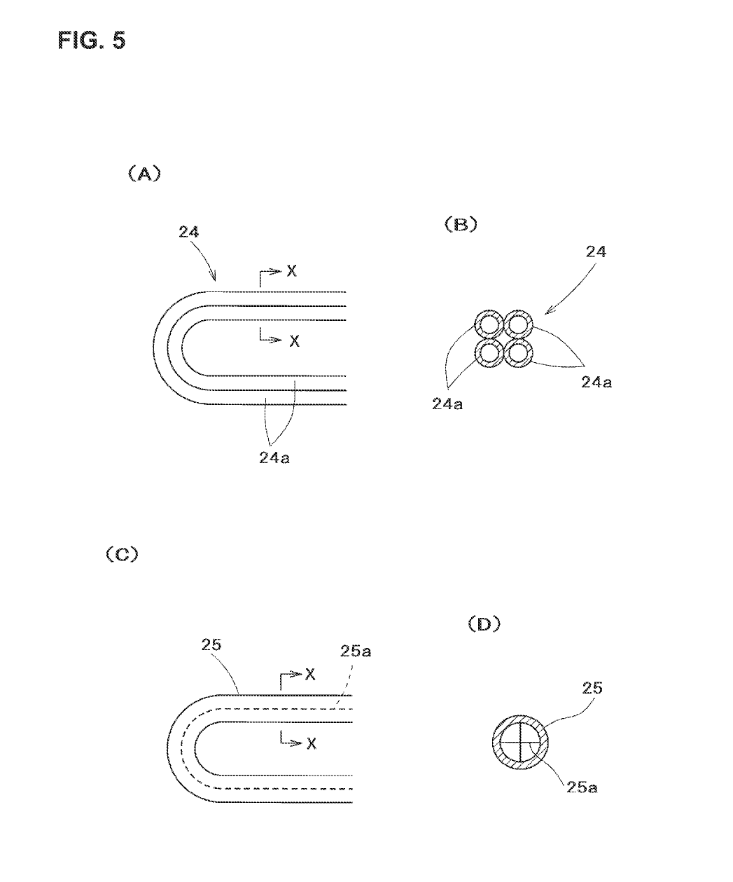

Further, a configuration is also possible in which piping for cooling is divided into a plurality of flow paths which are disposed in parallel. In this case, for example, like piping for cooling 24 of a fifth embodiment shown in FIGS. 5(A) and 5(B), by forming the piping for cooling 24 by disposing a plurality of small-diameter branch pipes 24a (in FIGS. 5(A) and 5(B), four small-diameter branch pipes 24a are shown; however, it is not limited thereto and the small-diameter branch pipes 24a may be two, three, or five or more) in parallel, it is possible to make a configuration in which the piping for cooling 24 is divided into a plurality of flow paths. Then, due to such a configuration, stirring and heat convection due to turbulence at the time of flow in the small-diameter branch pipes 24a are reduced, and thus high-temperature hydraulic oil which is discharged from a hydraulic actuator and low-temperature hydraulic oil in the piping for cooling 24 can be prevented from being stirred, and in addition, the surface area of the piping for cooling 24 is increased, and thus a cooling effect is increased. Further, like a sixth embodiment shown in FIGS. 5(C) and 5(D), even if a partition member 25a partitioning a flow path into a plurality of flow paths is provided in piping for cooling 25, it is possible to make a configuration in which the piping for cooling 25 is divided into a plurality of flow paths. Then, even in a case of being configured in this manner, it is possible to reduce stirring and heat convection due to turbulence at the time of flow in the piping for cooling 25.

Further, in the piping for cooling in the present invention, heat exchange between the hydraulic oil in the piping for cooling and the outside air is performed on the surface of the piping for cooling. However, in this case, a configuration of cooling the piping for cooling by natural draft is also acceptable. However, it is also possible to separately provide cooling means for forcibly cooling the piping for cooling. As the cooling means, for example, heat dissipation fins which are attached to the piping for cooling, a cooling fan for supplying cooling air to the piping for cooling, or the like can be adopted. Then, by providing such cooling means, it is possible to more effectively cool the hydraulic oil in the piping for cooling.

In addition, the present invention can be implemented in not only the hydraulic circuit for the boom cylinder of the hydraulic shovel, but also hydraulic circuits for various working machines such as a crane, for example.

### INDUSTRIAL APPLICABILITY

The present invention can be applied to hydraulic circuits for various working machines provided with an accumulator for accumulating hydraulic energy which is discharged from a hydraulic actuator.

### REFERENCE SIGNS LIST

1: boom cylinder
9: accumulator inflow/outflow oil passage
10: accumulator
12, 21, 22, 24, 25: piping for cooling
17: accumulator inflow oil passage
23: floating body

1. A hydraulic circuit for a working machine provided with an accumulator, comprising:
a hydraulic actuator; and
the accumulator which accumulates hydraulic energy which is discharged from the hydraulic actuator, and on the other hand, supplies the accumulated hydraulic energy to the hydraulic actuator,
wherein piping for cooling having a volume equivalent to accumulation volume of the accumulator is disposed in an inflow oil passage of hydraulic oil to the accumulator, and the hydraulic oil cooled in the piping for cooling is accumulated in the accumulator.

2. The hydraulic circuit for a working machine provided with an accumulator according to claim 1, wherein the piping for cooling is disposed in a meandering shape or a spiral shape.

3. The hydraulic circuit for a working machine provided with an accumulator according to claim 1, wherein the piping for cooling is divided into a plurality of flow paths which are disposed in parallel.

4. The hydraulic circuit for a working machine provided with an accumulator according to claim 1, wherein the piping for cooling is disposed in an accumulator inflow/outflow oil passage serving as an oil passage for inflow and outflow of the hydraulic oil to and from the accumulator, and a floating body which moves along with flow of the hydraulic oil, thereby preventing mixing of the hydraulic oil, is disposed in the piping for cooling.

5. The hydraulic circuit for a working machine provided with an accumulator according to claim 1, further comprising: cooling means for cooling the hydraulic oil flowing through the piping for cooling.
